(19) United States
(12) Patent Application Publication
(10) Pub. No.: US 2018/0018412 A1
(43) Pub. Date: Jan. 18, 2018

(54) Fluid Flow Network Simulation Methods and Systems Employing Two-Phase Envelopes with Interpolated Values

(71) Applicant: Landmark Graphics Corporation, Houston, TX (US)

(72) Inventors: Zhiqiang GU, Katy, TX (US); Terry Wong, Houston, TX (US)

(73) Assignee: Landmark Graphics Corporation, Houston, TX (US)

(21) Appl. No.: 15/545,865

(22) PCT Filed: Sep. 17, 2015
(86) PCT No.: PCT/US2015/050774

§ 371 Date: Jul. 24, 2017

(51) Int. Cl. G06F 17/50; G01V 99/00; E21B 43/16; G01V 1/34

(52) U.S. Cl. CPC G06F 17/5009; G01V 99/005; E21B 43/16; G01V 1/345; G06F 2217/16

(57) ABSTRACT

A method includes modeling a fluid flow network, the fluid flow network having a surface pipeline network connected between a plurality of well perforation nodes and a common outlet or inlet. The method also includes generating a plurality of two-phase envelopes for the modeled fluid flow network, where each two-phase envelope has at least some interpolated values and corresponds to a section of the modeled fluid flow network with a constant flow composition. The method also includes determining phase equilibrium information for the modeled fluid flow network based on the generated two-phase envelopes. The method also includes applying the determined phase equilibrium information to production or simulation related to the fluid flow network.

### BACKGROUND

Modern oil field operators demand a great quantity of information relating to the parameters and conditions encountered downhole. The information obtained can be used to make decisions regarding well placement, well completion, well intervention, ongoing production, and/or other operations. Simulation of fluid properties and fluid flow is one of the tools available to modern oil field operators. In a conventional reservoir simulation program, the flow of fluids is tracked within the reservoir until it reaches the perforations of the wells. It is also possible to connect a surface network model to the reservoir model. As an example, a surface network model may be used to simulate fluid flow entering well perforations and continuing through the wellbore tubing string, the pipes at the surface, the separator batteries, and/or other surface facilities such as a central gas facility. The surface network model may also model fluid flow in the reverse direction from a source of fluid injection to the well perforations.

Fluid flow simulations are computationally expensive and typically involve various inputs such as initial reservoir fluid compositions, temperatures, and pressures at different points of space in the reservoir and the surface network. From the inputs, the simulation re-calculates the conditions of composition, temperature, and pressure at later times for the same points of space. At each space and time location, fluid property and phase equilibrium equations are solved to determine the number of phases, the amount of each phase, and the composition of each phase. The properties (e.g., density and viscosity) of each phase can then be calculated and used to calculate pressure variations that affect fluid flow in both the reservoir and the surface network. The computational time spent in phase equilibrium calculations is a significant part of the overall simulation time. For example, in a conventional simulation procedure, a full phase behavior calculation may be performed for each sub-section of each segment of a surface network model. Even where a single phase exists in the previous solution of a sub-section, a phase transition calculation is performed to determine if a second phase will appear. This phase transition calculation may take the form of a saturation pressure calculation, or a Gibbs stability test, or a series of flash calculations. On the other hand, if two phases exist in the previous solution of a sub-section, flash calculations are performed to determine either a new two phase state or if the system has become single phase. Efforts to reduce the computational overhead of such calculations are ongoing.

### BRIEF DESCRIPTION OF THE DRAWINGS

Accordingly, there are disclosed in the drawings and the following description fluid flow network simulation methods and systems employing two-phase envelopes with interpolated values. In the drawings:

FIG. 1 is a block diagram showing an illustrative hydrocarbon production system.

FIG. 2 is a schematic diagram showing an illustrative surface network.

FIG. 3 is a schematic diagram showing an illustrative connection between two nodes of a surface network model.

FIG. 4 is a diagram showing an illustrative two-phase envelope and example phase adjustment paths.

FIG. 5 is a flowchart showing an illustrative method for obtaining phase equilibrium information.

FIG. 6 is a block diagram showing illustrative simulation system components.

FIG. 7 is a block diagram showing an illustrative computer system to perform phase equilibrium analysis and/or related operations.

FIG. 8 is a schematic diagram showing an illustrative data volume in three dimensions.

FIG. 9 is a flowchart showing an illustrative simulation method.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are fluid flow network simulation methods and systems employing two-phase envelopes with interpolated values. The use of interpolated values expedites the process of generating two-phase envelopes, where each two-phase envelope corresponds to a section of a modeled fluid flow network with a constant flow composition. Once generated, each two-phase envelope can be used to determine phase equilibrium information for the corresponding sections of the modeled fluid flow network. The determined phase equilibrium information can be employed for other calculations or operations. For example, pressure variations at different points in a modeled fluid flow network (e.g., the difference between the tubing head pressure and the bottom hole pressure) can be calculated based on the determined phase equilibrium information. The phase equilibrium information or values derived from the phase equilibrium information can be applied to simulations of fluid flow in a surface network and/or a reservoir. In at least some embodiments, simulation results based at least in part on the phase equilibrium information or values derived from the phase equilibrium information are used to direct well or production planning operations. Examples of well or production planning operations include making decisions regarding determining the number of wells in a reservoir, the placement of wells, perforation options, back pressure options, moderated flow rate options, separator condition option, injection rate options, and/or composition options. As desired, simulation results can be displayed on a computer monitor or portable device to facilitate decision-making by reservoir or production planners and operators. Besides employing two-phase envelopes with interpolated values, other options to expedite determining phase equilibrium information for a modeled fluid flow network include selective use of interpolated K-values that define the ratio of the gas phase mole fraction and the oil phase mole fraction of a component. In at least some embodiments, a simulator as described herein may apply historical data as well as various rules/constraints to one or more fluid flow network models in order to predict future reservoir and network performance under different operating conditions. In this manner, the performance of an existing or future surface network can be optimized.

In at least some embodiments, an example method includes modeling a fluid flow network, the modeled fluid flow network having a surface pipeline network connected between a plurality of well perforation nodes and a common outlet or inlet. The method also includes generating a plurality of two-phase envelopes for the modeled fluid flow network, where each two-phase envelope has at least some interpolated values and corresponds to a section of the modeled fluid flow network with a constant flow composition. The method also includes determining phase equilibrium information for the modeled fluid flow network based at least in part on the generated two-phase envelopes. The method also includes applying the determined phase equilibrium information to production or simulation operations related to the modeled fluid flow network. Meanwhile, an example system includes a memory having a simulation program, and one or more processors coupled to the memory. The simulation program, when executed, causes the one or more processors to model a fluid flow network, the fluid flow network having a surface pipeline network connected between a plurality of well perforation nodes and a common outlet or inlet. The simulation program, when executed, further causes the one or more processors to generate a plurality of two-phase envelopes for the modeled fluid flow network, where each phase envelope has at least some interpolated values and corresponds to a section of the fluid flow network with a constant flow composition. The simulation program, when executed, further causes the one or more processors to determine phase equilibrium information for the modeled fluid flow network based at least in part on the generated two-phase envelopes. The simulation program, when executed, further causes the one or more processors to apply the determined phase equilibrium information to production or simulation operations related to the modeled fluid flow network.

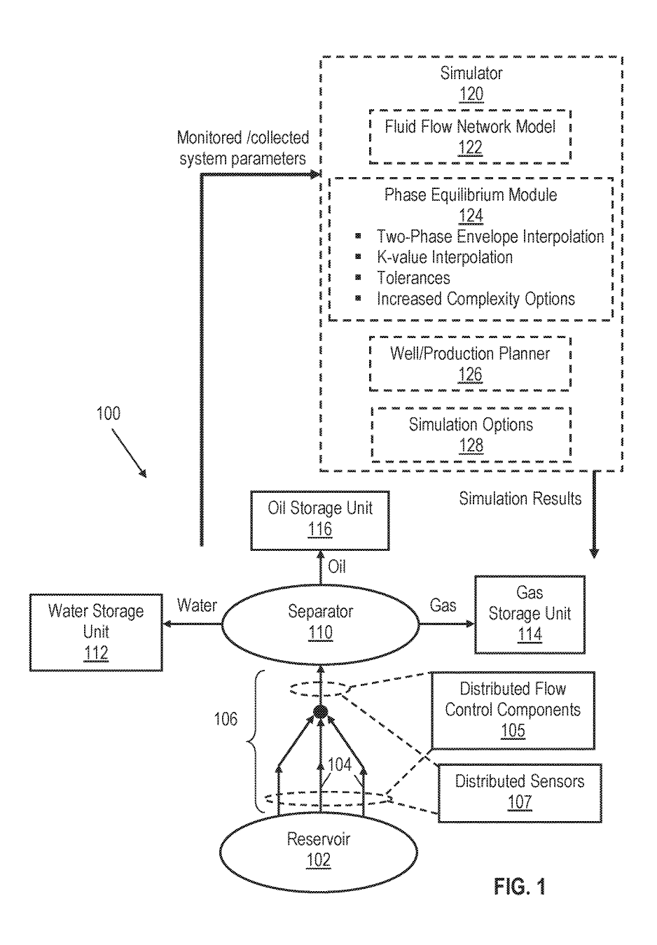

FIG. 1 shows an illustrative hydrocarbon production system 100. The illustrated hydrocarbon production system 100 includes a collection of wells 104 extending from a reservoir 102, where the arrows representing the wells 104 show the direction of fluid flow (i.e., wells 104 represent production wells). Although only production wells are shown, hydrocarbon production system 100 could also include injection wells. Further, the hydrocarbon production system 100 also includes distributed flow control components 105 and/or distributed sensors 107.

In FIG. 1, a surface network 106 is represented and corresponds to pipelines connected between well perforation nodes and a common outlet or inlet. For example, in at least some embodiments, the surface network 106 transports fluid from the wells 104 to a separator 110, which directs water, oil, and gas to separate storage units 112, 114, and 116. The water storage unit 112 may direct collected water back to reservoir 102 or elsewhere. The gas storage unit 114 may direct collected gas back to reservoir 102, to a gas lift interface (not shown), or elsewhere. The oil storage unit 116 may direct collected oil to one or more refineries. In different embodiments, the separator 110 and storage units 112, 114, and 116 may be part of a single facility or part of multiple facilities associated with the hydrocarbon production system 100. Although only one oil storage unit 116 is shown, it should be understood that multiple oil storage units may be used in the hydrocarbon production system 100. Similarly, multiple water storage units and/or multiple gas storage units may be used in the hydrocarbon production system 100.

In FIG. 1, a simulator 120 receives monitored/collected system parameters from the hydrocarbon production system 100 and provides simulations results. The simulation results can be applied to the hydrocarbon production system 100, to another existing hydrocarbon production system, and/or to a future hydrocarbon production system. The simulator 120 includes various components related to the disclosed methods and systems. In at least some embodiments, the simulator 120 represents, for example, one or more computers executing software or other instructions. In at least some embodiments, the simulator 120 receives historical monitored system parameters such as fluid flow rates, fluid compositions, temperatures, and pressures from various components of the hydrocarbon production system 100, and determines various production predictions under future operating conditions for the hydrocarbon production system 100. It should be understood that the data for simulation program 120 has been collected over a long period of time of perhaps many years. Rather than provide information on the entire state of hydrocarbon production system 100, the discussion of simulation program 120 is limited to its employment of two-phase envelope interpolation, K-value interpolation, and/or other options to reduce the overhead of phase equilibrium analysis and related operations within a fluid flow network. One of ordinary skill in the art would understand that the simulator 120 may perform various other operations in a time-segmented manner.

As shown, the simulator 120 includes a fluid flow network model 122. In at least some embodiments, the fluid flow network model 122 represents pipelines connected between well perforation nodes and a common outlet or inlet. The simulator 120 also includes a phase equilibrium module 124. The phase equilibrium module 124 may correspond to, for example, instructions executed by one or more processors to determine phase equilibrium information for some or all of the fluid flow network model 122. In at least some embodiments, the phase equilibrium module 124 employs two-phase envelope interpolation, K-value interpolation, tolerances, and increased complexity options. As an example, two-phase envelope interpolation and/or K-value interpolation can be employed to expedite determining phase equilibrium information subject to accuracy tolerances. If results of two-phase envelope interpolation are determined to fall outside of a tolerance threshold or range, then the process of identifying the two-phase envelope can be repeated or adjusted using additional data points (e.g., to fill in the two-phase envelope and/or to guide interpolation) or other increased complexity options that improve accuracy. Similarly, if results of K-value interpolation are determined to fall outside of a tolerance threshold or range, then the process of identifying K-values can be repeated or adjusted using additional data points (e.g., a full flash operation can be performed) or other increased complexity options that improve accuracy.

Once the phase equilibrium module 124 determines phase equilibrium information that is accurate to within a tolerance threshold or range, the phase equilibrium information can be applied to other calculations such as determining pressure variations at different points in the fluid flow network model 122 (e.g., the difference between the tubing head pressure and the bottom hole pressure). Further, a well/production planner 126 may use the phase equilibrium information or values derived from the phase equilibrium information to model production operations (e.g., predicting the best settings for the number of wells in a reservoir, the placement of wells, perforation options, back pressure options, moderated flow rate options, separator condition option, injection rate options, and/or composition options). Further, simulation options module 128 may use phase equilibrium information or values derived from the phase equilibrium information to simulate fluid flow in a surface network and/or a reservoir. Further, as desired, the phase equilibrium information, values derived from the phase equilibrium information, and/or related simulation results can be displayed on a computer monitor or portable device to facilitate decision-making by reservoir or production planners and operators. In at least some embodiments, the simulator 120 receives monitored/collected system parameters and outputs simulation results based on the fluid flow network model 122, the phase equilibrium module 124, the well/production planner 126, and/or the simulation options module 128. The simulation results may be based at least in part on the monitored/collected system parameters. Besides physical parameters of fluids in the hydrocarbon production system 100 (e.g., obtained from distributed sensors 107) or besides control component status or parameters (e.g., obtained from distributed flow control components 105), the monitored/collected system parameters may include target production criteria (e.g., how much oil or gas is needed for a particular scenario).

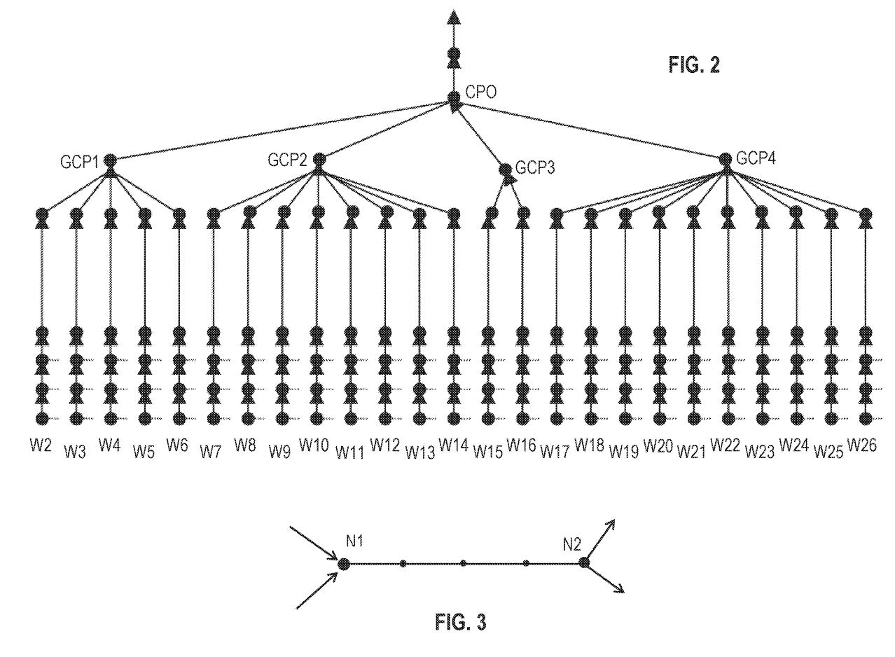

FIG. 2 is a schematic diagram showing an illustrative surface network. For each of the wells represented (W2-W26), there are multiple nodes representing perforations where the reservoir fluid enters the network. The fluid flows upward through each wellbore and ties together at gathering center points (GCP1-GCP4). The fluids at each gathering center point flow together and connect to a common production outlet (CPO). Different surface networks can have different arrangements of wells and gathering center point hierarchies. Regardless of the particular arrangement, a surface network can be modeled as a set of interconnected nodes, where the fluid flow or other attributes of the surface network is solved as a steady state system so that there is no accumulation of mass at the nodes.

In at least some embodiments, pressure, temperature, and/or other parameters are solved for or set at measured values at each node. Thereafter, fluid properties are calculated for each connection between two nodes to calculate the flow rate of each connection. The properties of the fluids can be calculated, for example, by an equation of state (EOS) correlation. In the fluid properties calculation, the phase equilibrium calculations are solved to provide the number of phases, the amount of each phase, and the composition of each phase. Then, the properties of each phase such as the density and the viscosity are calculated. Without limitations, the inputs for phase property calculations may be the average pressure, temperature, and overall composition of the fluid. As desired, a connection can be subdivided into many segments, and fluid properties can be calculated individually for each segment. For all the segments within one connection, or possibly for several connections that are sequentially joined, there is only one inlet and one outlet for the entire length. Because the solution is steady state without any accumulation of mass at the nodes, the flow composition of each calculation point along a given connection is constant.

FIG. 3 is a schematic diagram showing an illustrative connection between two nodes (N1 and N2) of a surface network model. For the connection between N1 and N2, the flow compositions are constant and hence amenable to equilibrium analysis based on the same two-phase envelope. As shown, two inlet connections join at N1, where each inlet connections may carry same composition or a different composition. Meanwhile, N2 is a separator connection, where the outlet fluid is split (e.g., between a vapor and a liquid phase) according to the predetermined separator conditions. When analyzing the connection between N1 and N2, fluid property calculations may be performed at spaced points for hydraulic calculations.

As described herein, disclosed embodiments use the constant composition for a particular connection between nodes to reduce the complexity of calculations for the particular connection. The pressure and the temperature may still vary at the different points of calculation. However, it is less expensive and more accurate to extend results for changes in temperature and/or pressure than for changes in composition. As described herein, full phase behavior calculations can be performed at a few select points of a connection, and then properties are estimated at other points of the connection by approximations.

In at least some embodiments, the pressure and temperature at each node and at intermediate points between nodes is calculated during an iterative solution process. The flow rate for all connections between nodes is also calculated, so that the composition for each connection is known. For each iteration, a fixed temperature, pressure, and composition may be used. The calculated pressure and temperature values can be used as input data to calculate the fluid properties for each segment of a connection.

In at least some embodiments, phase property calculations start with the determination of the phase state within each segment of constant composition. While a water phase may or may not be flowing, the water phase can be omitted from the phase equilibrium calculations. Without limitation, the disclosed methods and systems may calculate at any point of a surface network whether one of three hydrocarbon phase states exist, where the phase states are: (1) both oil and gas phases; (2) only an oil phase; and (3) only a gas phase.

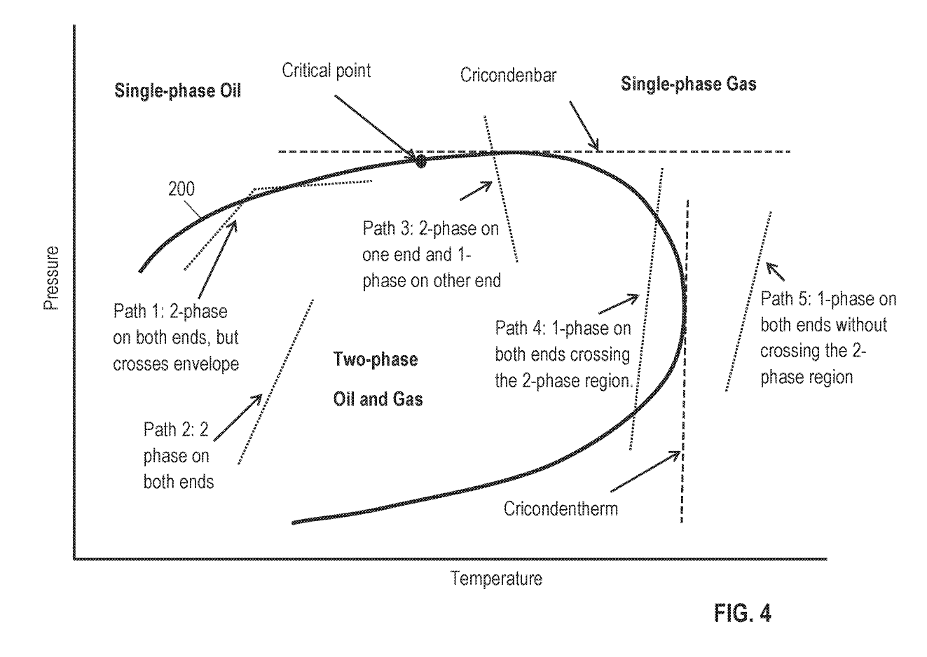

To determine how a more limited set of calculations are to be performed, the phase state in different parts of a connection is identified using a two-phase envelope. FIG. 4 is a diagram showing an illustrative two-phase envelope 200 and example phase adjustment paths (labeled paths 1-5), where the two-phase envelope defines the boundary between single-phase and two- phase states for a given multi-component composition as a function of temperature and pressure. For each composition in a surface network model, a different two-phase envelope can be determined and used as described herein. The two-phase envelope 200 includes a critical point that defines a critical pressure and a critical temperature. The portion of the two-phase envelope 200 that extends leftward from the critical point is known as the bubble point curve. Meanwhile, the portion of the two-phase envelope 200 that extends rightward from the critical point is known as the dew point curve. It can be seen that for each particular temperature along the bubble point curve, there is only one boundary corresponding to the bubble point pressure. At pressures above the bubble point pressure, the related composition exists as a single-phase oil. At pressures below the bubble point pressure, two phases exists. In contrast, for at least some temperatures along the dew point curve, upper and lower boundaries are possible. The upper boundary is known as the high pressure dew point and the lower boundary is known as the low pressure dew point. The maximum temperature of the two-phase region is known as the cricondentherm (represented as a vertical dashed line) and the maximum pressure of the two-phase region is known as the cricondenbar (represented as a horizontal dashed line). For temperatures above the cricondentherm and for pressures above the cricondenbar, phase analysis of a composition can be simplified because only a single hydrocarbon phase exists

In at least some embodiments, phase analysis of the composition along a connection involves using a two-phase envelope to identify the phase state at the ends (the nodes) of the connection. Three possible scenarios are: (1) at both nodes, two hydrocarbon phases exist; (2) at one node, a two phase state exists, and at the other node, a single phase state exists; and (3) at both nodes, a single-phase state exists. However, the phase between nodes of a connection may follow many possible phase adjustment paths as illustrated by the example phase adjustment paths 1-5. Thus, even if both nodes of a connection are in the same phase state and even if pressure and temperature follow a monotonic behavior, it is possible that the phase adjustment path between nodes of a connection can cross in and out of the two-phase region multiple times.

To determine if a phase adjustment path crosses a two-phase boundary, a two-phase envelope (e.g., two-phase envelope 200) for a constant composition is first generated as a geometric curve using estimated values such as extrapolated values or interpolated values. For example, in at least some embodiments, a saturation pressure calculation may be performed at a low value of pressure and temperature. Then, several points on the rest of the curve are extrapolated sequentially by using derivatives of pressure and temperature in a multi-stage extrapolation. If the pressure for a section of the two-phase envelope is between two temperatures where saturation pressure values are available, interpolation is used to estimate the saturation pressure. Use of estimated values for the two-phase envelope is not as precise as calculating of the actual saturation pressure at each temperature, but the computation complexity is reduced (e.g., the cost of generating the entire two-phase envelope curve will be naturally less if the calculations at done only a few points of pressure and temperature rather than at the conditions of all the points in a section of constant composition. Additionally, we will outline estimation procedures which allow us to extend the solution at a single that to that of other conditions.) In cases where the pressure along the phase adjustment path approaches the estimated saturation pressure (i.e., if a phase adjustment path is determined to be near the two-phase boundary), the estimated envelope position can be refined with finer interpolation or other such procedures. For more information on techniques to expedite generation of a two-phase envelope, reference may be had to Michelsen, M. L., A Simple Method for Calculation of Approximate Phase Boundaries, Fluid Phase Equilibria, 98, 1-11 (1994).

Without limitation to other techniques to generate a two-phase envelope, one suitable technique involves calculating the saturation pressure at a low temperature to initialize the solution. Then, the entire envelope is extrapolated from this point. At the initial solution, the incipient phase composition is designated as yᵢ* and a reference set of K-values is defined as:

$${K}_{i}^{*} = \frac{{y}_{i}^{*}}{{z}_{i}} , i = 1 , … , nc \qquad ( 1 )$$

where zᵢ is the overall composition for component i, and nc is the total number of components. The approximate incipient phase compositions are then generated by:

$$\begin{matrix}log ( {Y}_{i}^{inc} ) = log ( {z}_{i} ) + γ log ( {K}_{i}^{*} ) , i = 1 , … , nc & ( 2 ) \\ {y}_{i}^{inc} = \frac{{Y}_{i}^{inc}}{{\sum }_{i = 1}^{nc} {Y}_{i}^{inc}} , i = 1 , … , nc & ( 3 )\end{matrix}$$

At the initialization point, the variable y starts out equal to 1. By definition, it is 0 at the critical point. As the dew point line is generated, it becomes negative. At each stage of the phase envelope generation, only three equations are solved. A variable d is defined as:

dᵢ=ln(yᵢ^{inc})+ln(φᵢ)(yᵢ^{inc}))−ln(φᵢ(zᵢ)) (4)

where Eq. 4 defines the difference in component fugacities between phases. In Eq. 4, φᵢ(yᵢ^{inc}) are the fugacity coefficients of the incipient phase, while φᵢ(zᵢ) are the fugacity coefficients of the overall fluid. The three equations to be solved are:

f₁=Σᵢ₌₁^{nc}yᵢ^{inc}dᵢ=0 (5)

f₂=Σᵢ₌₁^{nc}zᵢdᵢ=0 (6)

f₃=y−S=0 (7)

where S is a specified value of y for each computational stage. Initially, S is set equal to 1, so that the first set of Kᵢ* are the K-values from the initial saturation pressure calculation. In each subsequent step, the value S is reduced by a small amount. When the value of S declines below 0, dew points are calculated. The marching step continues until the maximum desired temperature is reached.

The three equations are solved by a Newton-Raphson method. The system of equations can be described with the notation:

f(α)=0 (8)

The independent variables in this case are:

a^{T}=(log(T) , log(p),y) (9)

where T is the temperature and p is the pressure. The Newton-Raphson method can be expressed as:

$$\frac{\partial f}{\partial α} Δ α + f ( α ) = 0 \qquad ( 10 )$$

where

$$\frac{\partial f}{\partial α}$$

is the Jacobian matrix with elements ∂fᵢ/∂aⱼ, i=1, . . . , 3, j=1, . . . ,3. Further Δa is the vector of changes in the independent variables. No compositional derivatives are required. The derivatives

$$\frac{\partial {f}_{1}}{\partial γ} and \frac{\partial {f}_{2}}{\partial γ}$$

may be generated numerically. Then, the sensitivities of the independent variables with respect to the specified variable S are evaluated and Eq. 10 is differentiated with respect to S, leading to:

$$\frac{\partial f}{\partial α} \frac{\partial α}{\partial S} + \frac{\partial f}{\partial S} = 0 \qquad ( 11 )$$

Because only f₃ depends on S, the following is true:

$$\frac{\partial f}{\partial S} = {( 0 , 0 , - 1 )}^{T} \qquad ( 12 )$$

After Eq. 10 is solved, the inverse or LU decomposition of the Jacobian matrix is retained. The system is resolved with the same Jacobian matrix but with a different right-hand side,

$$\frac{\partial f}{\partial S}$$

instead of f , resulting in a solution for

$$\frac{\partial α}{\partial S} .$$

As a second step, the solution is linearly extrapolated to a higher temperature by applying

$$α ( {S}_{2} ) = α ( {S}_{1} ) + ( {S}_{2} - {S}_{1} ) \frac{\partial α}{\partial S} \qquad ( 13 )$$

Eqs. 10 and 11 can then be solved again at the second solution point. Afterward, the values of a and

$$\frac{\partial α}{\partial S}$$

at two points are known. These provide sufficient information to calculate the coefficients of a cubic polynomial for each independent variable.

aᵢ(S)=a_{i,0}+a_{i,1}S+a_{i,2}S²+a_{i,3}S³ (14)

Thus, an extrapolation to a new point can be performed based on the last two points. Eqs. 10 and 11 are resolved at this point, and the process is repeated for the entire envelope.

Typically, the marching procedure related to Eqs. 1 to 14 has no trouble generating the two-phase envelope or passing through the critical region. As needed, the size of the marching step can be adjusted. For example, if the Newton-Raphson solution fails to converge or converges in more than three iterations, the step size is reduced. If it converges in less than three iterations, the step size is increased. For each marching step, the calculated incipient compositions will not be as accurate as the ones calculated by a saturation pressure algorithm. The error grows greater with each step, but is usually less than a few percent at the end of the procedure.

In at least some embodiments, the magnitude of dᵢ of Eq. 4 can be used to judge if the fast procedure is accurate enough. If it is deemed to be not accurate enough, one of two possible ways can be used to improve it. First, it is possible that a Newton-Raphson algorithm can be solved using a system of nc+1 equations. The first nc equations are the fugacity equality equation for each component. This forces the fugacities of each component to be set equal between phases, instead of using a summation of the differences where errors can cancel out. The equations are expressed as:

ln(yᵢ^{inc})+ln(φᵢ(yᵢ^{inc}))−ln(φᵢ(xᵢ))=0,i=1, . . . , nc (15)

Another criteria that may be used is expressed as:

Σᵢ₌₁^{nc}(yᵢ^{inc}−zᵢ)=0 (6)

This set of equations usually converges very quickly but only if the compositions for the fast procedure are sufficiently close to the actual solution. If this fix-up procedure is unable to converge, the following iterative procedure is used. The incipient compositions are modified by the following equation:

$${Y}_{i} = {z}_{i} \frac{{ϕ}_{i} ( {z}_{i} )}{( {ϕ}_{i} ( {y}_{i}^{inc} )} \qquad ( 17 )$$

Then, a Newton-Raphson solution is used to calculate pressure by solving

Q₂=1−Σᵢ₋₁^{nc}Yᵢ (18)

The solution of Eqs. 17 and 18 are repeated until Q₂ is less than a specified tolerance.

Regardless of how the improved compositions (y̅ᵢ) are generated, the reference set of K-values is re-defined as:

$$log ( {K}_{i}^{*} ) = \frac{1}{γ} log [ \frac{{\overline{y}}_{i}}{{z}_{i}} ] \qquad ( 19 )$$

As the phase envelope temperatures approach the cricondentherm, the maximum temperature, it may be useful to exactly identify its value. This is because for any pipe segment that has its temperature above that of the cricondentherm, a single gas phase is guaranteed. Without limitation to other techniques, the cricondentherm can be calculated using the method proposed in Taraf, R., Behbahani, R., and Moshfeghian, M., Direct Prediction of Cricondentherm and Cricondenbar Coordinates of Natural Gas Mixtures Using Cubic Equation of State, Int J Thermophys 29 (6): 1954-1967 (2008).

From the initial guess generated by the phase envelope calculation, the temperature is refined by solving

$$\frac{\partial Q}{\partial p} = 0 \qquad ( 20 )$$

where Q can be a modified tangent plane criteria as in Michelsen, Saturation Point Calculations, Fluid Phase Equilibria, 23 (2-3): 181-192 (1985). The modified tangent plane criteria can be expressed as:

Q₁=1−Σᵢ₋₁^{nc}yᵢ^{inc}−Σᵢ₌₁^{nc}yᵢ^{inc}[ln(yᵢ^{inc})+ln(φᵢ(yᵢ^{inc}))−ln(zᵢ)−ln(φᵢ(zᵢ))] 21)

or

Q₂=1−Σᵢ₌₁^{nc}Yᵢ (22)

where yᵢ is defined by Eq. 17. One of these two equations is solved for temperature by a non-linear iterative method such as Newton-Raphson or bisection. For difficult phase envelopes, it is possible to use a more stringent procedure which is more costly, but which will provide phase envelopes pressures that are as accurate as the ones generated by individual saturation pressure calculations. In at least some embodiments, this procedure is based on the phase envelope generation routine described in Michelsen, M. L., Calculation of Phase Envelopes and Critical Points for Multicomponent Mixtures, Fluid Phase Equilibria, 4 (1-2): 1-10 (1980). In this procedure, nc+2 equations are solved simultaneously using the Newton-Raphson method, where the first nc+1 equations are Eqs. 15 and 16. One additional criteria that may be used is:

aₛ−S=0 (23)

where a is the vector of independent variables. Further,

a^{T}=(log(K₁^{inc}), . . . , log(K_{nc}^{inc}),log(p), log(T)) (24)

where a_{S} is the variable that has its value specified to be S. In Eq. 24, the equilibrium constant Kᵢ^{inc} is defined as the ratio of incipient mole fraction to the overall mole fraction:

Kᵢ^{inc}=yᵢ^{inc}/zᵢ,i=1, . . . , nc (25)

As an initial step, a saturation pressure is computed at a low value of pressure and temperature because this is inexpensive and easy to converge. Initially, the starting temperature is specified so that a_{S}=ln(T). Similar to the fast phase envelope procedure, the sensitivities of the independent variables with respect to the specified variable aₖ are evaluated by resolving the system of equations with the same Jacobian, but a different right-hand-side. The solution provides the vector ∂s/∂a. Then similar to the fast procedure, in the first extrapolation step, a linear extrapolation is employed, where each subsequent extrapolation step uses a cubic equation extrapolation.

The key to this alternative procedure is the choice of the specified variable a_{S}. The extrapolations work best if a_{S} is selected to be the one that has the largest rate of change (i.e., the one with the largest value of

$$\frac{\partial α}{\partial S} ) .$$

In most instances, this variable will be ln(K) for the least volatile component on the bubble point side and ln(K) for the most volatile component on the dew point side. In this procedure, a different specification variable may be chosen for each step of the march. Like the fast envelope procedure, the size of the marching step depends on the convergence of the current step.

Regardless of how the two-phase envelope is generated, the disclosed calculation involves, for each pipe segment, an evaluation of the saturation pressure at the temperature of the segment. Further, interpolation between the points calculated for the two-phase envelope is performed. For example, interpolation may be performed by solving the cubic equation (Eq. 14) for pressure after the value of the specification variable at the desired temperature is calculated.

For connections (or segments within a connection) that have a two-phase state (e.g., indicated by a phase adjustment path having some portion within the two-phase envelope), additional operations are performed. For example, in at least some embodiments, a flash calculation (e.g., see Eq. 30 below) may be performed using a cubic equation of state at the nodes of a connection (or at the ends of a segment within a connection), and actual K-values are generated for the nodes or segment ends. Then, interpolated K-values are derived at conditions that lie between the ends of the two-phase connection or segment. The actual or interpolated K-values represent the ratio of the gas phase mole fraction and the oil phase mole fraction in the two-phase connection or segment, and can be expressed as:

Kᵢ=yᵢ/xᵢ,i=1, . . . , nc (26)

The K-value interpolations are performed with the following equations:

$$\begin{matrix}log ( {K}_{i} ( {T}_{1 ,} P ) ) = log ( {K}_{i} ( {T}_{1} , {P}_{1} ) {P}_{1} / P ) + \frac{\partial ( log ( {K}_{i} ( {T}_{1} , {P}_{1} ) {P}_{1} ) )}{\partial P} ( P - {P}_{1} ) & ( 27 ) \\ log ( {K}_{i} ( {T}_{2 ,} P ) ) = log ( {K}_{i} ( {T}_{2} , {P}_{2} ) {P}_{2} / P ) + \frac{\partial ( log ( {K}_{i} ( {T}_{2} , {P}_{2} ) {P}_{2} ) )}{\partial P} ( P - {P}_{2} ) & ( 28 ) \\ log ( {K}_{i} ( T , P ) ) = log ( {K}_{i } ( {T}_{1} , P ) ) + ( \frac{1}{T} - \frac{1}{{T}_{1 }} ) * ( log ( {K}_{i} ( {T}_{2} , P ) ) - log ( {K}_{i} ( {T}_{1} , P ) ) ) / ( \frac{1}{{T}_{2}} - \frac{1}{{T}_{1}} ) & ( 29 )\end{matrix}$$

Note: Interpolation with composition is not required because in each pipe segment, the composition is constant. In at least some embodiments, the flash calculation is performed using the Rachford-Rice procedure, expressed as:

$${\sum }_{i = 1}^{{n}_{c}} \frac{{z}_{i} ( {K}_{i} - 1 )}{1 + v ( {K}_{i} - 1 )} = 0 , \qquad ( 30 )$$

where n_{c} is the number of components, zᵢ is the overall mole fraction, and v is the mole fraction of the gas phase. Further, a Newton-Raphson iteration procedure may be used to calculate v. Using interpolated K-values is much less computationally-expensive compared to performing a full flash calculation, and the results are sufficient as long as the interpolated K-values are within a threshold tolerance. The tolerance threshold can be determined by the sensitivity of the actual solution to variances in the K-values.

Sometimes the interpolation will be insufficient because the actual K-values do not interpolate and/or do not follow the correlation model closely enough. To detect such issues, actual K-values can be successively calculated for different segments ends within a connection. If the actual K-values do not conform with the correlation model, a full flash can be performed with the actual K-values.

During phase equilibrium calculations, phase equilibrium information from the previous time step or network iteration can be used as an initial guess. The information from upstream/downstream nodes can also be used to obtain a better initial guess if there is a considered change in pressure, temperature or mass flow rate for each individual component. In at least some embodiments, a suitable flash calculation is expressed as Eq. 30.

The phase equilibrium information determined from Eq. 30 and/or other calculations can be used to determine pressure variations at different points in a modeled fluid flow network (e.g., the difference between the tubing head pressure and the bottom hole pressure). Further, the phase equilibrium information or values derived from the phase equilibrium information can be used to direct production operations (e.g., controlling a valve, pump, or gas lift operations). Further, the phase equilibrium information or values derived from the phase equilibrium information can be applied to simulations of fluid flow in a surface network and/or a reservoir. As desired, the phase equilibrium information or values derived from the phase equilibrium information can be displayed on a computer monitor or portable device to facilitate decision-making by reservoir or production planners and operators.

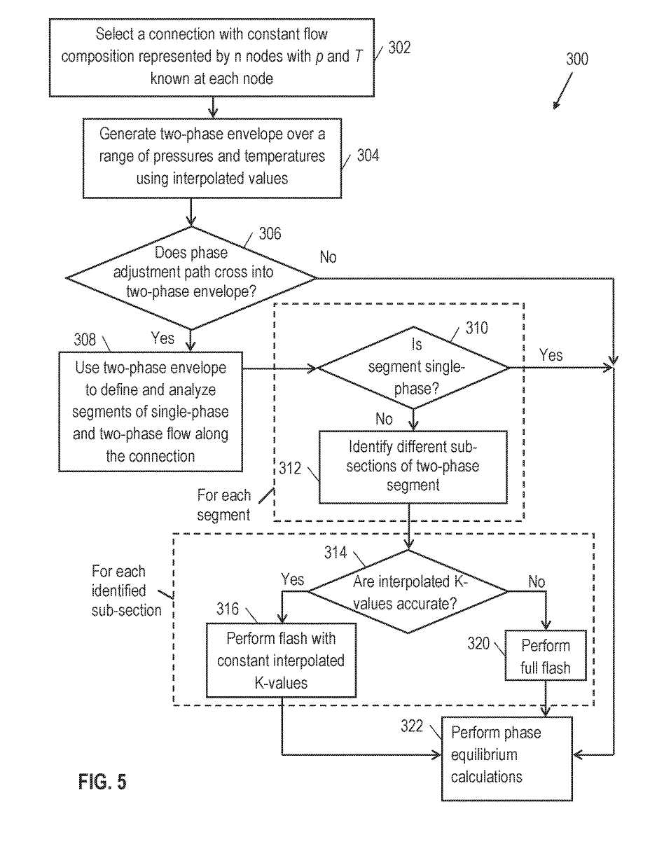

FIG. 5 is a flowchart showing an illustrative method 300 for obtaining phase equilibrium information. At block 302, a connection (of a surface network model) with a constant flow composition is selected. The connection may be represented, for example, by n nodes with pressure (p) and temperature (T) known at each node. At block 304, a two-phase envelope is generated for the constant flow composition over a range of pressures and temperatures using at least some interpolated values. Additionally or alternatively, generation of the two-phase envelope at block 304 may involve use of extrapolated values and/or other estimated values. At decision block 306, a determination is made regarding whether a phase adjustment path crosses into the two-phase envelope. If the phase adjustment path does not cross into the two-phase envelope (decision block 306), phase equilibrium calculations are performed based in part on single-phase values for the connection at block 322. On the other hand, if the phase adjustment path crosses into the two-phase envelope (decision block 306), the two-phase envelope is used to define and analyze segments of single-phase and two-phase flow along the connection (block 308). For each segment, a determination is made regarding whether the segment is single-phase (decision block 310). If so, then phase equilibrium calculations are performed at block 322 based in part on single-phase information for that segment. Otherwise, different sub-sections of the two-phase segment are identified at block 312. For each identified sub-section, a determination is made regarding whether interpolated K-values for the sub-section are accurate (decision block 314). Without limitation, the K-values may correspond to the ends of each sub-section. If the interpolated K-values are not sufficiently accurate (decision block 314), a full flash calculation is performed at block 320, and phase equilibrium calculations are performed at block 322 based at least in part on the full flash calculations of block 320. On the other hand, if the interpolated K-values are sufficiently accurate (decision block 314), a flash calculation with constant interpolated K-values is performed at block 316, and phase equilibrium calculations are performed at block 322 based at least in part on the flash calculations of block 322.

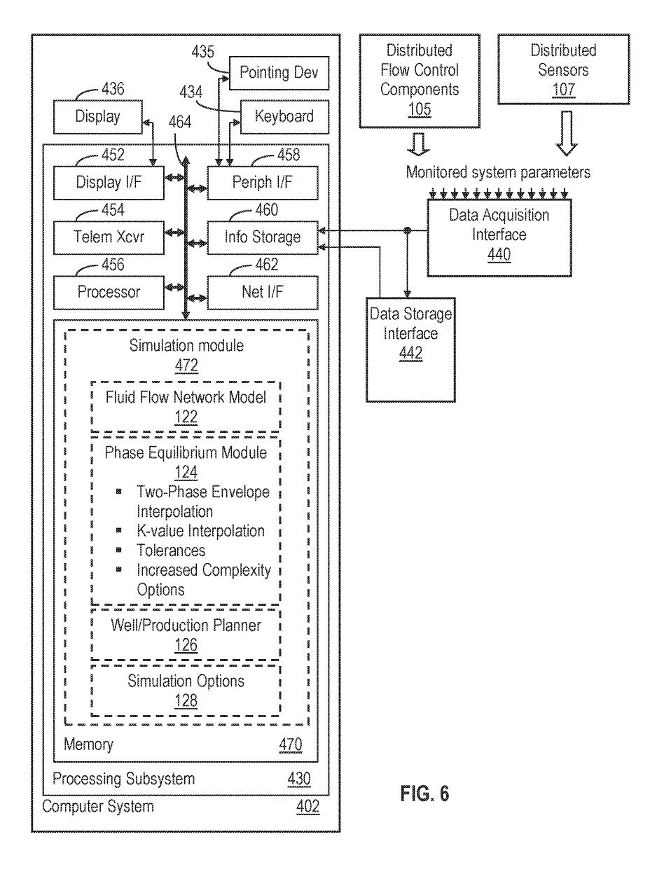

FIG. 6 is a block diagram showing illustrative simulation system components related to the methods and systems described herein. As an example, the represented simulation system components may at least carry out the operations of simulator 120 (see FIG. 1). As shown, the simulation system components of FIG. 6 include a computer system 402 coupled to a data acquisition interface 440 and/or a data storage interface 442 in communication with the distributed flow control components 105 and the distributed sensors 107. The data acquisition interface 440 and/or the data storage interface 442 operate to track or store the status of or measurements from the distributed flow control components 105 and the distributed sensors 107. In at least some embodiments, the obtained status information or measurements can be input to the computer system 402 as part of the process of determining phase equilibrium information and performing related operations (e.g., production management or simulation) as described herein.

In at least some embodiments, a user is able to interact with computer system 402 via keyboard 434 and pointing device 435 (e.g., a mouse) to determine phase equilibrium information and to perform related operations (e.g., production management or simulation). As shown, the computer system 402 includes a processing subsystem 430 with a display interface 452, a telemetry transceiver 454, a processor 456, a peripheral interface 458, an information storage device 460, a network interface 462 and a memory 470. Bus 464 couples each of these elements to each other and transports their communications. In some embodiments, telemetry transceiver 454 enables the processing subsystem 430 to communicate with downhole and/or surface devices (either directly or indirectly), and network interface 462 enables communications with other systems (e.g., a central data processing facility via the Internet). In accordance with embodiments, user input received via pointing device 435, keyboard 434, and/or peripheral interface 458 are utilized by processor 456 to determine phase equilibrium information and/or to perform related operations as described herein. Further, instructions/data from memory 470, information storage device 460, and/or data storage interface 442 are utilized by processor 456 to determine phase equilibrium information and/or to perform related operations as described herein.

As shown, the memory 470 comprises a simulation module 472. More specifically, in at least some embodiments, the simulation module 472 includes the fluid flow network model 122 described for FIG. 1. The simulation module 472 also includes the phase equilibrium module 124 that enables computer system 402 to determine phase equilibrium information based at least in part on two-phase envelope interpolation, K-value interpolation, tolerances, and/or increased complexity options as described herein. The simulation model 472 also includes production simulation program126 to predict production operations based at least in part on the phase equilibrium information or related values obtained using the phase equilibrium module 124. Further, the simulation module 472 includes the simulation manager 128 to perform fluid flow simulations for a surface network and/or a reservoir based at least in part on the phase equilibrium information or related values obtained using the phase equilibrium module 124.

In at least some embodiments, the simulation module 472, when executed, causes the computer system 402 to perform various steps including modeling a fluid flow network. The modeled fluid flow network may represent, for example, a surface pipeline network connected between a plurality of well perforation nodes and a common outlet or inlet. The simulation module 472, when executed, may further cause the computer system 402 to generate a plurality of two-phase envelopes for the modeled fluid flow network, wherein each two-phase envelope has at least some interpolated values and corresponds to a section of the modeled fluid flow network with a constant flow composition. In at least some embodiments, generating each two-phase envelope involves a saturation pressure calculation and extrapolating points along a curve using derivatives of pressure and temperature. The simulation module 472, when executed, may further cause the computer system 402 to determine phase equilibrium information for the modeled fluid flow network based on the generated two-phase envelopes. In at least some embodiments, determining the phase equilibrium information involves identifying one-phase segments and two-phase segments of the modeled fluid flow network based on the generated two-phase envelopes. As an example, identifying one-phase segments and two-phase segments may involve determining whether a phase adjustment path that varies as a function of temperature and pressure for a particular composition flow crosses into a respective two-phase envelope. For each identified two-phase segment, interpolated K-values may be determined. Further, the simulation module 472, when executed, may further cause the computer system 402 to determine if the interpolated K-values are within a tolerance threshold. If the interpolated K-values are determined to be within the tolerance threshold, the interpolated K-values are used to determine phase equilibrium information. Otherwise, a two-phase flash calculation is performed, and results of the two-phase flash calculation are used to determine phase equilibrium information. Once the phase equilibrium information is determined, the simulation module 472 may apply the determined phase equilibrium information to calculate other values (e.g., pressure drops), to perform production adjustment operations (e.g., adjusting a valve or pump of the fluid flow network), and/or to adjust a production or reservoir simulation.

In at least some embodiments, the simulation module 472, when executed, may cause the computer system 402 to generate a visual representation of fluid flow or related parameters. Such visual representations may enable an operator to evaluate fluid flow as a function of time and to assist with production decisions and/or other ongoing operations. Although the various components 472, 122, 124, 126, and 128 are described as software modules executable by a processor (e.g., processor 456), it should be understood that comparable operations may be performed by programmable hardware modules, application-specific integrated circuits (ASICs), or other hardware.

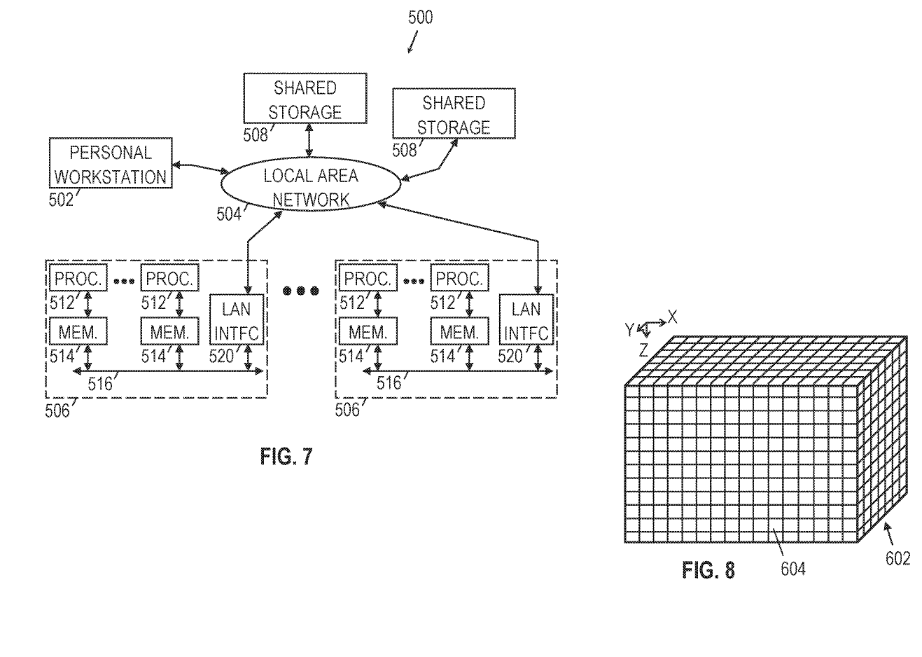

FIG. 7 shows an illustrative computer system 500 to perform phase equilibrium analysis and/or related operations. In FIG. 7, the computer system 500 includes a personal workstation 502 coupled via a local area network (LAN) 504 to one or more multi-processor computers 506, which are in turn coupled via the LAN 504 to one or more shared storage units 508. Personal workstation 502 serves as a user interface to the processing system, enabling a user to load collected data, models, and/or simulation data into the system, to retrieve and view resulting information or images, and to configure and monitor the operation of the processing system. Personal workstation 502 may take the form of a desktop computer with a monitor that graphically shows collected data, fluid flow model data/options, phase equilibrium data/options, simulation data/options, and/or images representing a fluid flow network and/or reservoir. The personal workstation 502 also may include input devices (e.g., keyboard and mouse) that enable the user to move files and execute processing software.

LAN 504 provides high-speed communication between multi-processor computers 506 and with personal workstation 502. The LAN 504 may take the form of an Ethernet network. Meanwhile, multi-processor computer(s) 506 provide parallel processing capability to determine phase equilibrium information and/or to perform related operations. Each computer 506 includes multiple processors 512, distributed memory 514, an internal bus 516, and a LAN interface 520. Each processor 512 operates on an allocated portion of the input data to produce phase equilibrium information for some of a modeled fluid flow network and/or to perform related operations. Associated with each processor 512 is a distributed memory module 514 that stores software and a working data set for the processor's use. Internal bus 516 provides inter-processor communication and communication to the LAN networks via interface 520. Communication between processors in different computers 506 can be provided by LAN 504. As an example, shared storage units 508 may be large, stand-alone information storage units that employ magnetic disk media for nonvolatile data storage. To improve data access speed and reliability, the shared storage units 508 may be configured as a redundant disk array.

In at least some embodiments, the phase equilibrium information described herein can used to calculate or adjust a three-dimensional array of data values used to represent a reservoir. Collected survey data, earth model data, simulation data, and/or other values may likewise be used to calculate or adjust the three-dimensional array of data values. The collected survey data, earth model data, simulation data, and/or other data is of little use when maintained in a raw data format. Hence such data is sometimes processed to create a data volume, i.e., a three-dimensional grid of data values such as the data volume 602 of FIG. 8. The data volume 602 represents a distribution of formation characteristics throughout a region of interest. The three-dimensional grid may be comprised of structured or unstructured cells 604, each cell 604 having data values representing one or more formation characteristics for that cell or having a null value. Examples of suitable formation characteristics include porosity, permeability, and density. Further, the composition of matter and fluid flow attributes for each cell 604 can be calculated or adjusted as needed. The volumetric data format readily lends itself to computational analysis and visual rendering, and for this reason, the data volume 602 may be termed a “three-dimensional image” of the region of interest.

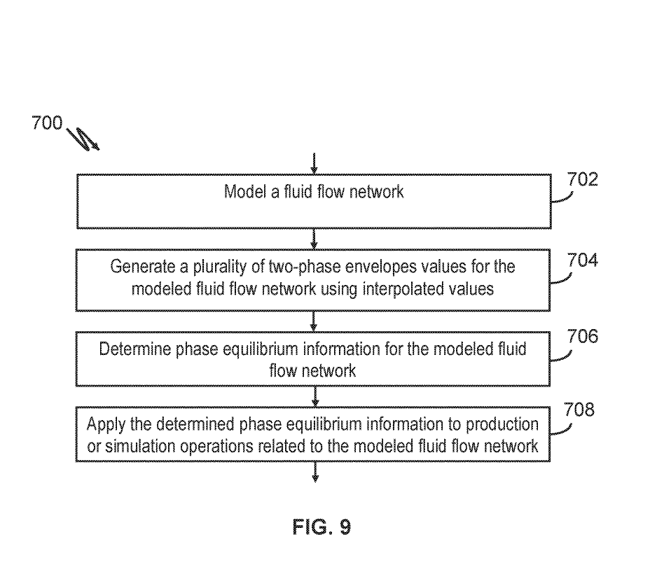

FIG. 9 is a flowchart showing an illustrative simulation method 700. As an example, the method 700 may be performed at least in part by the simulator 120 of FIG. 1, the computer system 402 of FIG. 6, the personal workstation 502 of FIG. 7, and/or the multi-processor computers 506 of FIG. 7. As shown, the method 700 includes modeling a fluid flow network at block 702. In at least some embodiments, the modeled fluid flow network includes a surface pipeline network connected between a plurality of well perforation nodes and a common outlet or inlet. The method 700 also includes generating a plurality of two-phase envelopes for the modeled fluid flow network at block 704, where each two-phase envelope corresponds to a section of the modeled fluid flow network with a constant flow composition. To expedite determining phase equilibrium information, two-phase envelopes may be generated using at least some interpolated values as described herein. At block 706, phase equilibrium information for the modeled fluid flow network is determined based at least in part on the generated two-phase envelopes. At block 708, the determined phase equilibrium information is applied to production or simulation related to the modeled fluid flow network. For example, the determined phase equilibrium information can be used to calculate pressure variations at different points in a modeled fluid flow network (e.g., the difference between the tubing head pressure and the bottom hole pressure). Further, the phase equilibrium information or values derived from the phase equilibrium information can be used to direct production operations (e.g., controlling a valve, pump, or gas lift operations). Further, the phase equilibrium information or values derived from the phase equilibrium information can be applied to simulations of fluid flow in a surface network and/or a reservoir. As desired, the phase equilibrium information or values derived from the phase equilibrium information can be displayed on a computer monitor or portable device to facilitate decision-making by reservoir or production planners and operators.

Embodiments disclosed herein include:

A: A method that comprises modeling a fluid flow network, the modeled fluid flow network having a surface pipeline network connected between a plurality of well perforation nodes and a common outlet or inlet. The method also comprises generating a plurality of two-phase envelopes for the modeled fluid flow network, wherein each two-phase envelope has at least some interpolated values and corresponds to a section of the modeled fluid flow network with a constant flow composition. The method also comprises determining phase equilibrium information for the modeled fluid flow network based at least in part on the generated two-phase envelopes. The method also comprises applying the determined phase equilibrium information to production or simulation related to the fluid flow network.

B: A system that comprises a memory having a simulation program and one or more processors coupled to the memory. The simulation program, when executed, causes the one or more processors to model a fluid flow network, the fluid flow network having a surface pipeline network connected between a plurality of well perforation nodes and a common outlet or inlet. The simulation program, when executed, also causes the one or more processors to generate a plurality of two-phase envelopes for the modeled fluid flow network, wherein each phase envelope has at least some interpolated values and corresponds to a section of the fluid flow network with a constant flow composition. The simulation program, when executed, also causes the one or more processors to determine phase equilibrium information for the modeled fluid flow network based at least in part on the generated two-phase envelopes. The simulation program, when executed, causes the one or more processors to apply the determined phase equilibrium information to production or simulation related to the fluid flow network.

Each of the embodiments, A and B, may have one or more of the following additional elements in any combination. Element 1: wherein generating each two-phase envelope involves a saturation pressure calculation and extrapolating points along a curve using derivatives of pressure and temperature. Element 2: wherein determining the phase equilibrium information comprises identifying one-phase segments and two-phase segments of the modeled fluid flow network based on the generated two-phase envelopes. Element 3: wherein said identifying one-phase segments and two-phase segments comprises determining whether a phase adjustment path that varies as a function of temperature and pressure crosses into a respective two-phase envelope. Element 4: further comprising determining interpolated K-values for at least one of the identified two-phase segments. Element 5: further comprising determining if the interpolated K-values are within a tolerance threshold. Element 6: further comprising using the interpolated K-values with said determining phase equilibrium information in response to determining that the interpolated K-values are within the tolerance threshold. Element 7: further comprising performing a two-phase flash calculation in response to determining that the interpolated K-values are not within the tolerance threshold, and using results of the two-phase flash calculation with said determining phase equilibrium information. Element 8: further comprising adjusting a valve or pump of the fluid flow network based on the determined phase equilibrium information. Element 9: further comprising adjusting a network or reservoir simulation based on the determined phase equilibrium information.

Element 10: wherein the simulation program, when executed, causes the one or more processors to generate each phase envelope based on a saturation pressure calculation and based on extrapolating points along a curve using derivatives of pressure and temperature. Element 11: wherein the simulation program, when executed, causes the one or more processors to determine the phase equilibrium information by identifying one-phase segments and two-phase segments of the modeled fluid flow network based on the generated two-phase envelopes. Element 12: wherein the simulation program, when executed, causes the one or more processors to identify one-phase segments and two-phase segments by determining whether a phase adjustment path that varies as a function of temperature and pressure crosses into a respective two-phase envelope. Element 13: wherein the simulation program, when executed, further causes the one or more processors to determine interpolated K-values for at least one of the identified two-phase segments. Element 14: wherein the simulation program, when executed, further causes the one or more processors to determine if the interpolated K-values are within a quality threshold. Element 15: wherein the simulation program, when executed, further causes the one or more processors to use the interpolated K-values to determine the phase equilibrium information in response to determining that the interpolated K-values are within the quality threshold. Element 16: wherein the simulation program, when executed, further causes the one or more processors to perform a two-phase flash calculation in response to determining that the interpolated K-values are not within the quality threshold, and to use results of the two-phase flash calculation to determine the phase equilibrium information. Element 17: wherein the simulation program, when executed, further causes the one or more processors to provide valve or pump recommendations or settings based on the determined phase equilibrium information. Element 18: wherein the simulation program, when executed, further causes the one or more processors to adjust production or reservoir simulation based on the determined phase equilibrium information.

Numerous other modifications, equivalents, and alternatives, will become apparent to those skilled in the art once the above disclosure is fully appreciated. For example, although at least some software embodiments have been described as including modules performing specific functions, other embodiments may include software modules that combine or vary the functions of the modules described herein. Also, it is anticipated that as computer system performance increases, it may be possible in the future to implement the above-described software-based embodiments using much smaller hardware, making it possible to determine phase equilibrium information using on-site systems (e.g., systems operated within a well-logging truck located at the reservoir). Additionally, although at least some elements of the embodiments of the present disclosure are described within the context of monitoring real-time data, systems that use previously recorded data (e.g., “data playback” systems) and/or simulated data (e.g., training simulators) are also within the scope of the disclosure. It is intended that the following claims be interpreted to embrace all such modifications, equivalents, and alternatives where applicable.

1. A method that comprises:
modeling a fluid flow network, the modeled fluid flow network having a surface pipeline network connected between a plurality of well perforation nodes and a common outlet or inlet;
generating a plurality of two-phase envelopes for the modeled fluid flow network, wherein each two-phase envelope has at least some interpolated values and corresponds to a section of the modeled fluid flow network with a constant flow composition;
determining phase equilibrium information for the modeled fluid flow network based at least in part on the generated two-phase envelopes; and
applying the determined phase equilibrium information to production or simulation operations related to the modeled fluid flow network.

2. The method of claim 1, wherein generating each two-phase envelope involves a saturation pressure calculation and extrapolating points along a curve using derivatives of pressure and temperature.

3. The method of claim 1, wherein determining the phase equilibrium information comprises identifying one-phase segments and two-phase segments of the modeled fluid flow network based on the generated two-phase envelopes.

4. The method of claim 3, wherein said identifying one-phase segments and two-phase segments comprises determining whether a phase adjustment path that varies as a function of temperature and pressure crosses into a respective two-phase envelope.

5. The method of claim 3, further comprising determining interpolated K-values for at least one of the identified two-phase segments.

6. The method of claim 5, further comprising determining if the interpolated K-values are within a tolerance threshold.

7. The method of claim 6, further comprising using the interpolated K-values with said determining phase equilibrium information in response to determining that the interpolated K-values are within the tolerance threshold.

8. The method of claim 6, further comprising performing a two-phase flash calculation in response to determining that the interpolated K-values are not within the tolerance threshold, and using results of the two-phase flash calculation with said determining phase equilibrium information.

9. The method of claim 1, further comprising adjusting a valve or pump of the fluid flow network based on the determined phase equilibrium information.

10. The method of claim 1, further comprising adjusting a production or reservoir simulation based on the determined phase equilibrium information.

11. A system that comprises:
a memory having a simulation program; and
one or more processors coupled to the memory, wherein the simulation program, when executed, causes the one or more processors to:
model a fluid flow network, the fluid flow network having a surface pipeline network connected between a plurality of well perforation nodes and a common outlet or inlet;
generate a plurality of two-phase envelopes for the modeled fluid flow network, wherein each phase envelope has at least some interpolated values and corresponds to a section of the fluid flow network with a constant flow composition; and
determine phase equilibrium information for the modeled fluid flow network based at least in part on the generated two-phase envelopes; and
apply the determined phase equilibrium information to production or simulation operations related to the modeled simulation flow network.

12. The system of claim 11, wherein the simulation program, when executed, causes the one or more processors to generate each two-phase envelope based on a saturation pressure calculation and based on extrapolating points along a curve using derivatives of pressure and temperature.

13. The system of claim 11, wherein the simulation program, when executed, causes the one or more processors to determine the phase equilibrium information by identifying one-phase segments and two-phase segments of the modeled fluid flow network based on the generated two-phase envelopes.

14. The system of claim 13, wherein the simulation program, when executed, causes the one or more processors to identify one-phase segments and two-phase segments by determining whether a phase adjustment path that varies as a function of temperature and pressure crosses into a respective two-phase envelope.

15. The system of claim 13, wherein the simulation program, when executed, further causes the one or more processors to determine interpolated K-values for at least one of the identified two-phase segments.

16. The system of claim 15, wherein the simulation program, when executed, further causes the one or more processors to determine if the interpolated K-values are within a quality threshold.

17. The system of claim 16, wherein the simulation program, when executed, further causes the one or more processors to use the interpolated K-values to determine the phase equilibrium information in response to determining that the interpolated K-values are within the quality threshold.

18. The system of claim 16, wherein the simulation program, when executed, further causes the one or more processors to perform a two-phase flash calculation in response to determining that the interpolated K-values are not within the quality threshold, and to use results of the two-phase flash calculation to determine the phase equilibrium information.

19. The system of claim 11, wherein the simulation program, when executed, further causes the one or more processors to provide valve or pump recommendations or settings based on the determined phase equilibrium information.

20. The system of claim 11, wherein the simulation program, when executed, further causes the one or more processors to adjust production or reservoir simulation based on the determined phase equilibrium information.
